(19) United States
(12) Patent Application Publication
(10) Pub. No.: US 2012/0143642 A1
(43) Pub. Date: Jun. 7, 2012

(54) Fleet Management Revenue Assurance

(75) Inventor: Christopher Burton O'Neil, Wichita, KS (US)

(73) Assignee: AGCO CORPORATION, Duluth, GA (US)

(21) Appl. No.: 13/311,612

(22) Filed: Dec. 6, 2011

Related U.S. Application Data
(60) Provisional application No. 61/419,925, filed on Dec. 6, 2010.

(30) Foreign Application Priority Data
Dec. 6, 2011 (US) PCT/US11/63406

(51) Int. Cl. G06Q 10/08; G06Q 30/04; G06F 19/00

(52) U.S. Cl. 705/7.11; 701/32.3; 705/34

(57) ABSTRACT

Methods and systems for automatic inventorying and reporting of field operations are presented. The invention provides a method for automatically reporting the completion of a field harvest or product application. An apparatus data unit can transmit apparatus location and state data to a central inventory system (CIS), preferably embodied as a central server. The CIS can convert the apparatus data to agricultural elements that can be mapped to a business state for a particular field. The CIS can provide a report of the field business state to an administrative service for scheduling or billing purposes. The invention provides a layer of abstraction so that a report recipient need not have familiarity with agricultural terms in order to perform administrative tasks related to field and fleet management. The invention enables resource management and billing services to be performed in a timely, efficient and accurate manner.

### CROSS REFERENCE TO RELATED APPLICATIONS

This application claims the benefit of co-pending U.S. Provisional Application Ser. No. 61/419,925, filed Dec. 6, 2010, and entitled “Fleet Management Revenue Assurance”, which is entirely incorporated by reference herein.

### FIELD OF THE INVENTION

This invention pertains generally to methods and systems for reporting agricultural operations, and more particularly to automatic inventorying and reporting the completion of a field harvest or application.

### BACKGROUND

To increase productivity while decreasing operational costs, farmers have embraced precision farming techniques and automated systems that relieve vehicle operators of many of the navigational tasks and equipment maneuvers required to cultivate and harvest agricultural fields. Precision farming allows crop product to be applied to a particular field under field-specific parameters to optimize and better predict yield based on the particular characteristics of the field. Properly employed, precision farming techniques can reduce product, operator and equipment costs. Similarly, automated guidance systems, relying on geo-positioning satellites for accurate location data, and user input for designating specific tasks to be performed, can reduce operator error and fatigue, further mitigating costs.

While beneficial for reducing field operational costs, such systems may not address the administrative costs or inefficiencies associated with agricultural operations. Improving overall efficiency can include optimizing the scheduling, allocation, and reporting of human, product, and machine resources. Operator records of actual tasks performed can be used to schedule future operations. Coding, compiling and organizing the labor and materiel expenses for a plurality of operators, fields, and equipment for administrative purposes can be challenging, as the work performed is typically characterized in agricultural specific terms, requiring administrative systems and personnel to be cognizant of agricultural terms. Furthermore, while an operator may be required to maintain an activity log, operators may neglect to accurately record tasks or provide the task record to the proper authority in a timely manner.

### BRIEF DESCRIPTION OF THE DRAWINGS

FIG. 1 depicts an example system for automatic inventory reporting.

FIG. 2 depicts an example operating environment for a system for automatic inventory reporting

FIG. 3 depicts an example central inventory system.

FIG. 4 depicts a flow diagram of an example method of the invention.

FIG. 5 depicts a flow diagram of an example method of the invention.

FIG. 6A shows a flow diagram of an example method of the invention.

FIG. 6B depicts a continuation of the example method depicted in FIG. 6A.

FIG. 7 shows a flow diagram of an example method.

### OVERVIEW

Systems and methods for automatically inventorying and reporting field operations are provided. The invention creates a layer of abstraction so that an inventory management system, billing system, or other administrative system can receive a simple report of field operations that does not require recognition of the agriculture-specific aspects of the work performed. An example system of the invention can include an apparatus data unit (ADU) for capturing and communicating apparatus data such as state and location data. For example, an ADU can be in the form of a telemetry unit or transceiver deployed on an agricultural apparatus. The ADU can be configured to receive apparatus data from one or more sources. An example system can further include a central inventory system (CIS) for receiving apparatus data from an ADU, determining a field business state from the data, and providing a report of said business state. By way of example, a CIS can include a central computing device such as a server configured to communicate with an ADU over a network. An example system can include a report-receiving device (RRD) for receiving a report generated at the CIS. For example an RRD can be in the form of a communication device associated with an administrative service such as a scheduling or billing service that is configured to communicate with the CIS over a communications network.

An example method can include receiving apparatus data, determining a business state for a field based on said apparatus data, and providing a report. A CIS can be configured to receive apparatus data and determine whether the apparatus is located within a predetermined field. In addition, a CIS can convert the apparatus data to agricultural elements that can be used to determine a business state for a field. A CIS can be configured to provide a report of the business state to an RRD affiliated with an administrative service, such as a scheduling or billing service. Other reports can also be generated, for example a summary report of apparatus or operator activity.

### Detailed Description of Example Embodiments

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the exemplary embodiments are discussed in the context of an agricultural vehicle, it will be understood that the present invention is not limited to that particular arrangement. Likewise functions discussed in the context of being performed by a particular module or device may be performed by a different module or device without departing from the scope of the claims.

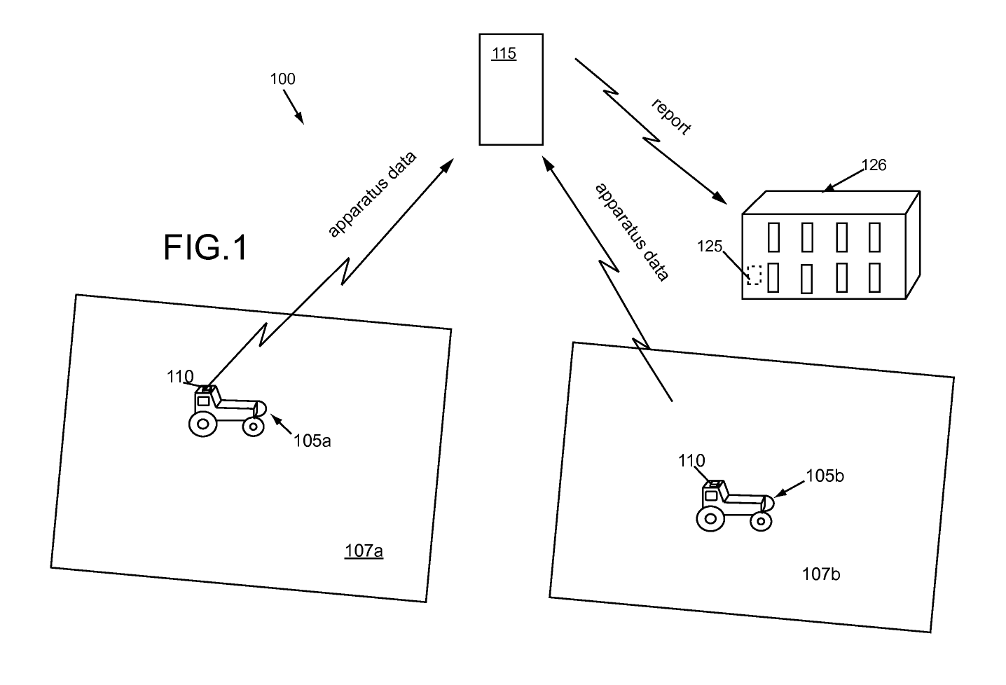

Referring now to the figures, the present invention will be described in detail. Referring to FIG. 1, a fleet management revenue assurance system 100 may include an agricultural apparatus 105a located in a field 107a is equipped with an apparatus data unit (ADU) 110. The ADU 110 is configured to provide apparatus data, such as location and state data, to a Central Inventory System (CIS) 115. Using the received apparatus data, the CIS 115 can determine agricultural elements, map the agricultural elements to a business state for the field 107a, and provide a report to a report-receiving device (RRD) 125 preferably associated with an administrative service 126. As shown in FIG. 1, the CIS 115 can be configured to receive apparatus data from a plurality of ADUs 110 on apparatus 105a . . . n in fields 107a . . . n and can provide a plurality of reports. This data could be combined, sorted, or otherwise manipulated to generate various reports relating to the agricultural apparatus, fields, operators, field owners, etc. as desired.

The agricultural apparatus 105a can be in the form of an agricultural vehicle, by way of example, but not limitation, a combine harvester, tractor, sprayer, or windrower. The apparatus 105 can be equipped with a variety of different implements, such as a cultivator, a header, a boom, etc. The apparatus 105a can be configured to perform various agricultural related tasks, such as harvesting crop, cultivating, applying crop products, irrigating, etc. The apparatus data provided by the ADU 110 can be used by the CIS 115 to determine the type of work performed by the apparatus 105a in the field 107a. The apparatus 105a and implement may be provided with a variety of sensors, actuators, and other tools to monitor the various states of the agricultural vehicle and the various implements as known in the art. Further details regarding the use of sensors to monitor implement state can be found in U.S. application Ser. No. 12/648,985 entitled “Auto-Detection of a Field in Fleet Management”, filed on Dec. 29, 2009, by Schmidt et al, which is assigned to the assignee of the present invention and incorporated in its entirety herein by reference.

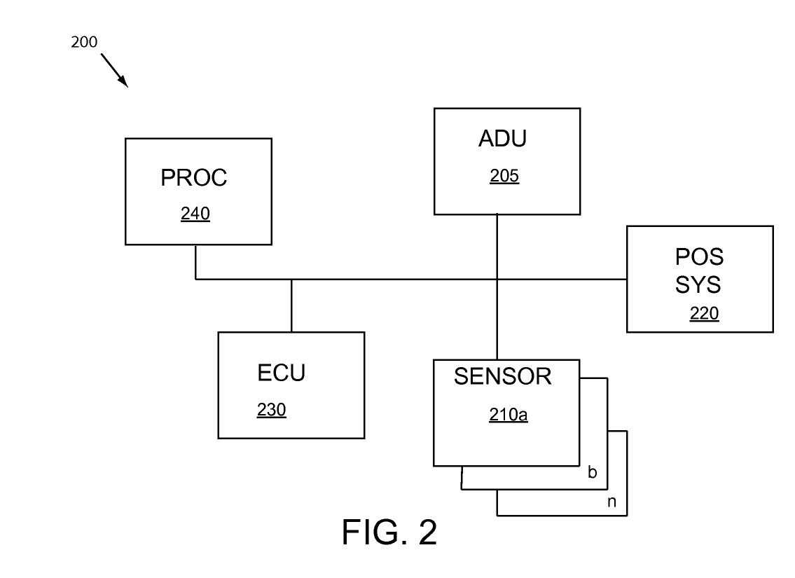

The ADU 110 can be embodied as a telemetry unit equipped with geo-positioning capability. For example, the ADU 110 can be configured to receive satellite signals from which it can determine a geographical position. In an example embodiment, the ADU 110 can determine a geographical position expressed in terms of latitude and longitude. Alternatively, as shown in the example operating environment 200 depicted in FIG. 2, an ADU 205 can be embodied as a telemetry unit coupled to a positioning system 220 having geo-positioning capability onboard the apparatus 105. In either case, the geographical position can be used as location data for the apparatus 105.

The ADU 205 can be configured to receive data from a plurality of sensors 210a . . . n or other inputs associated with the agricultural apparatus for which information is to be gathered. In an example embodiment, a sensor 210a can be positioned at a crop bin and configured to provide information regarding the weight or volume of harvested crop collected in the bin. In another example embodiment, a sensor 210b can be positioned at a supply container, and configured to provide data regarding the volume of consumable product remaining. The data acquired from the sensors 210a-n can be used to characterize and identify states of various apparatus components. The sensors 210a-n can comprise mechanical or electrical sensors as well as electronic assemblies or modules. It is further contemplated that, in addition to receiving data captured by the sensors 210a-n, the ADU 205 can receive status data from various apparatus devices or systems. In an illustrative example, the ADU 205 can receive data from an electronic control unit (ECU) 230 configured to control various aspects of an apparatus or an implement. For example, the ECU 230 can be embodied as an autosteer system such as the Auto-Guide™ system manufactured by AGCO® of Duluth, Ga. The ADU 205 can be configured to receive information from the ECU 230 regarding the state of an apparatus or implement. For example, an implement can be characterized as in a working position or a travel position, engaged or unengaged, activated or unactivated, etc. Additional information is disclosed in the Schmidt Application, previously referenced herein. The ADU 205 can be configured to receive data directly from various sensors or systems, or be configured to receive data from a processor 240 coupled to the sensors and systems and configured to coordinate operation and interaction among components.

The ADU 110 can be configured to provide apparatus state and location data to the CIS 115 by any suitable means, for example by communication over a communication network, which can include one or more networks, for example a local area network (LAN) and a wide area network (WAN). A wireless communications system, or a combination of wire line and wireless systems, may be utilized to send and receive apparatus data. Wireless can be defined as radio transmission via the airwaves. However, other transmission techniques including, but not limited to, infrared line of sight, cellular, microwave, satellite, packet radio, and spread spectrum radio can also be employed.

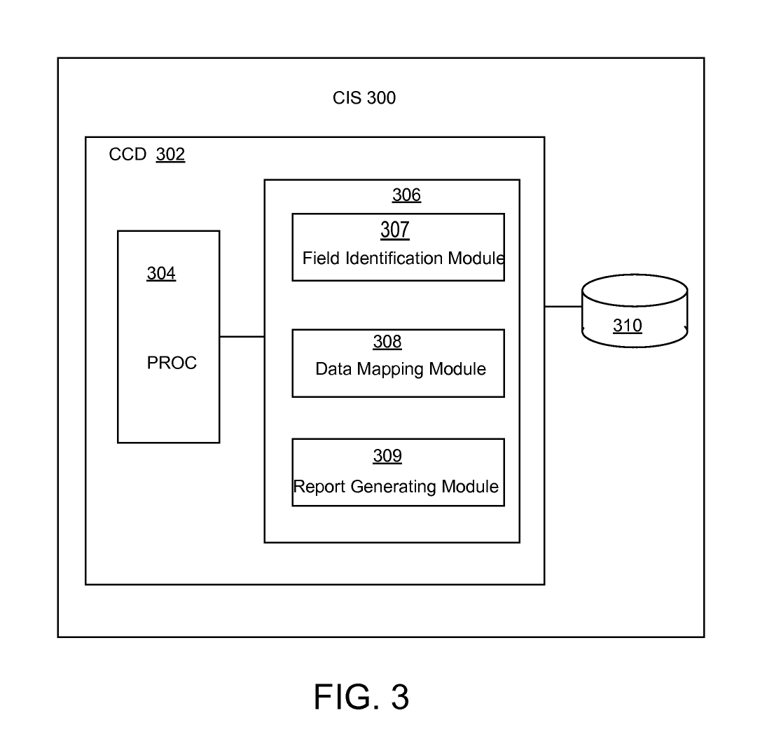

Referring to FIG. 3, an exemplary CIS 300 can comprise a central computing device (CCD) 302, for example, a central server, having a processor 304 and a memory 306 that can comprise read-only memory (ROM) for computing capabilities and random access memory (RAM), a removable disc (not shown), and/or other device for data storage capabilities, and a communications modem (not shown) for communications capabilities. By way of example, but not limitation, the CCD 302 can be implemented using a personal computer, a network computer, a mainframe, or microcomputer-based workstation or a smart phone. The CCD 302 can be coupled to a database 310 configured to store data in various records. The database 310 can be embodied as a separate data storage device or as part of the memory 306 resident at the CCD 302. In an exemplary embodiment, records can be indexed and maintained by field, apparatus, and operator. In addition, a field listing that identifies field parameters and associates an owner with each field can be stored at the database 310. In an exemplary embodiment, data can be formatted as defined in the ISO 11783 standard.

The CCD 302 can be configured to determine whether the apparatus is currently located within a field, and if so to determine the owner of the field. The CCD 302 can be configured to compare received apparatus geographical data, such as a location expressed in longitude and latitude coordinates, with predetermined field parameters to determine whether an apparatus is currently within a predefined field. For example, the CCD 302 can be configured to compare apparatus location with a field listing of predetermined field parameters and associated owners stored at the database 310. In an exemplary embodiment a field identification module (FIM) 307, comprising software, hardware, firmware or some combination thereof can be executed at the CCD 302 to determine whether an apparatus is located within a field. More information regarding FIM 307 operation can be found in U.S. application Ser. No. 12/648,985 entitled “Auto-Detection of a Field in Fleet Management”, incorporated previously herein.

The CCD 302 can be configured to use apparatus data to determine a business state for a field. In an exemplary embodiment, the CCD 302 is configured to receive apparatus data transmitted by the ADU 110, convert the apparatus data to agricultural elements, and use the agricultural elements to determine a business state for a particular field. Because the CCD 302 can map specific agricultural elements to a more generalized business state, a third party entity need not be familiar with specific agricultural terms or vehicle/implement attributes in order to use or understand a report provided by the CIS 300. For example, in an exemplary embodiment, the CCD 302 uses apparatus data to characterize the business state of a particular field as: 1) scheduled for work, 2) being worked, or 3) has been worked. In an exemplary embodiment, a data mapping module, comprising software, hardware, firmware or some combination thereof can be executed at the CCD 302 to determine a business state for a particular field. Additional business states can include 3) Billed, and 4) Accounts Paid.

The CCD 302 can be configured to provide one or more reports to the RRD 125. An example business report can include identification of a particular field, its owner and the current business state for a field. A plurality of fields can be included in a single report. It is contemplated that a variety of reports can be generated at the CCD 302. An example apparatus report can include a summary of activity performed by a particular apparatus. As a further example, an operator report can include a summary of activity performed by a particular operator. Data records stored at the database 310 can be used to generate reports, and the reports can be stored at the database 310 or the CCD 302 until provided to the RRD 125 associated with the AS 126. It is of particular interest to report that a field has been harvested or a field application has been completed because the owner of the filed can then be billed for the tasks completed. Automatically providing a business report indicating that a field has been worked allows a billing service to promptly bill the owner without requiring an administrator to understand agricultural terms or take the time to manually examine operator and apparatus logs.

By way of example, but not limitation, the AS 126 can be in the form of a scheduling service or billing service. As an example, the RRD 125 can be in the form of a computer coupled to a modem, and the CIS 115 and RRD 125 communicate by way of a wireless network, WAN, satellite network, LAN, wired network or other telecommunications network or combination of networks. Wireless data can include paging, text messaging, internet access, electronic mail, datagrams, and communications using other applications, such as smartphone widgets.

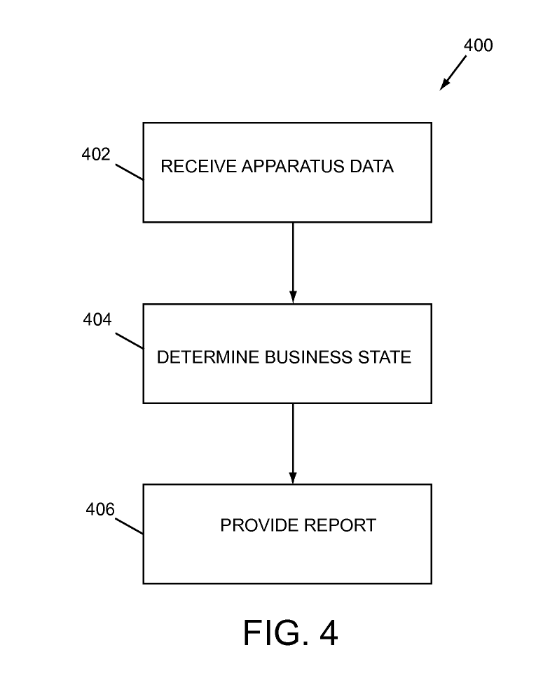

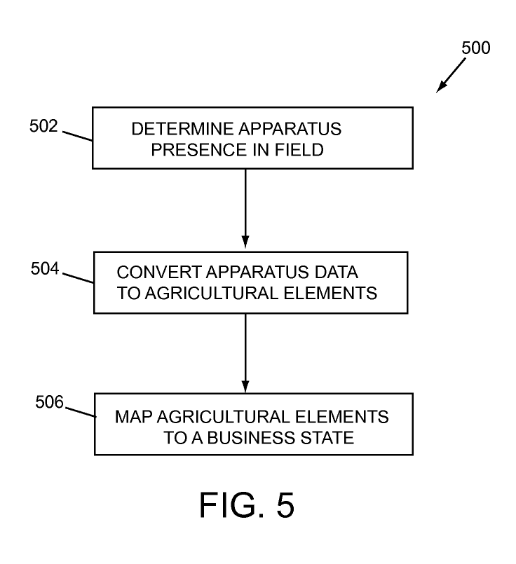

FIG. 4 depicts a flow diagram of an example method 400 for automatic inventorying and reporting. At block 402, apparatus data can be received. For example, apparatus data transmitted by the ADU 205 can be received at the CIS 115. The apparatus data stream can include apparatus identification information as well as operator identification data, and further include apparatus location and status information received at the ADU 205 from the sensors 210a-n, positioning system 220 and the ECU 230. A time and date stamp can be included in each ADU 205 transmission. The ADU 205 can communicate with the CIS 115 over one or more communication networks as discussed above. At block 404 a business state for a field can be determined. As an example, CCD 302 can use apparatus location data to determine whether a particular apparatus is located within a predefined field, and use apparatus state data to determine a business state for a particular field. An example method of determining a business state is depicted in FIG. 5 and discussed below. At block 406 a report based on the apparatus data can be provided. In an example embodiment, the CCD 302 transmits a report to the RRM 125 which can be associated with a billing service. In an exemplary embodiment, a report can identify one or more fields, its owner and its current business state. The billing service can use the report to bill field owners. A variety of reports can be provided by the CIS 300 including, but not limited to, a report of operator activity and a report of apparatus activity over a designated period of time. In an example embodiment, a report is generated under predetermined conditions such as: at predetermined time intervals, on predetermined dates, in response to a change in business state, or other conditions. Reports can also be generated in response to a report request by a user. The CIS 300 can provide a report over a communications network that can include wired, wireless, WAN, LAN and other types of networks as discussed above.

FIG. 5 depicts a flow diagram of an example method 500 for determining a business state for a field. At block 502, a determination is made as to whether an apparatus is located within a predefined field. In an exemplary embodiment, the database 310 includes a field listing record identifying one or more fields defined by predetermined parameters. In one example, a user interface can allow a user to load field parameters into the database and associate an owner with each defined field. Alternatively, a table of field parameters and owners can be stored on a storage medium provided to the CCD 302. The CCD 302 is configured to compare the location data to the predefined field parameters to determine whether an apparatus is located within a predetermined field. For example, if location data is expressed in longitude and latitude coordinates, the CCD 302 can be configured, perhaps through execution of the FIM 307, to determine whether the coordinates lie within the bounds defined by the field parameters stored in the field listing. If it is determined that an apparatus is located within a predetermined field, the owner of the field can be identified from the record stored in the database or storage medium which associates a field with its owner.

At block 504, apparatus status data can be converted to agricultural elements. An agricultural element refers to an expression of apparatus or operator activity related to agricultural operations. In an example embodiment, the DMM 308 at the CCD 302 is configured to record and convert apparatus data, and track changes of state to determine apparatus and/or operator activity. For example, sensor 210a data can indicate the volume or weight of crop material in a harvest bin. Data at successive time intervals can indicate that the weight or volume value has increased. The DMM 308 can convert that data to the agricultural element that the apparatus is harvesting crop. As another example, the sensor 210b can measure the weight or volume of herbicide or pesticide to be applied to a field. Data indicating that the weight has decreased can be converted to the agricultural element that a product has been applied to a field. As a further example, data from the ECU 230 can indicate that an apparatus implement is engaged or in a “ready” position as would be necessary to employ the implement and the agricultural apparatus is moving through the field with the implement engaged. The CCD 302 can convert this data to the agricultural element that an apparatus is using the implement to work a field. Similarly, changes in state can also indicate that an activity has ceased. For example, data indicating that an implement is no longer in a ready position can be converted to an agricultural element that the implement is no longer being used, or work has stopped. Likewise, sensor data indicating an applicant or herbicide weight or volume value is reduced to zero can indicate that an herbicide is no longer being applied, i.e. the agricultural element that work has stopped. The length of time the implement was engaged could also be measured.

At block 506 specific agricultural elements can be mapped to a generalized business state for a field. Mapping to a business state can be performed in a variety of ways, including but not limited to employing a mapping algorithm at the CCD 302 or using a look-up table stored at the database 310. For example an agricultural element of “harvesting crop” or “applying product” or “apparatus working” or “implement engaged” can be mapped to business state of “being worked” for a field in which an apparatus is located. An agricultural element of “work stopped” can be mapped to the business state “has been worked” for a field in which an apparatus was located. In an exemplary embodiment, a user can schedule a field for work through an interface that allows a user to provide information to the CIS 300. Once designated as scheduled for work, that business state can remain associated with the particular field until work is cancelled or work is begun on the field. The current business state can be stored in a field record at the database 310. In an example method, a business record can include one or more fields and a business state associated with each field.

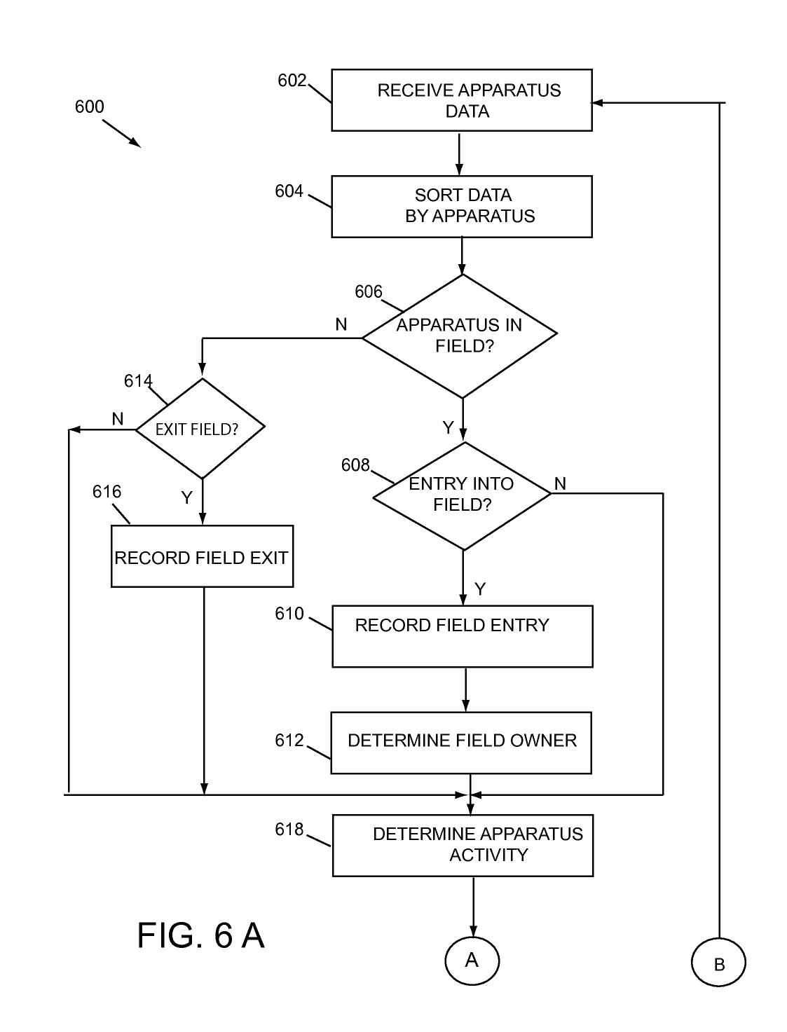

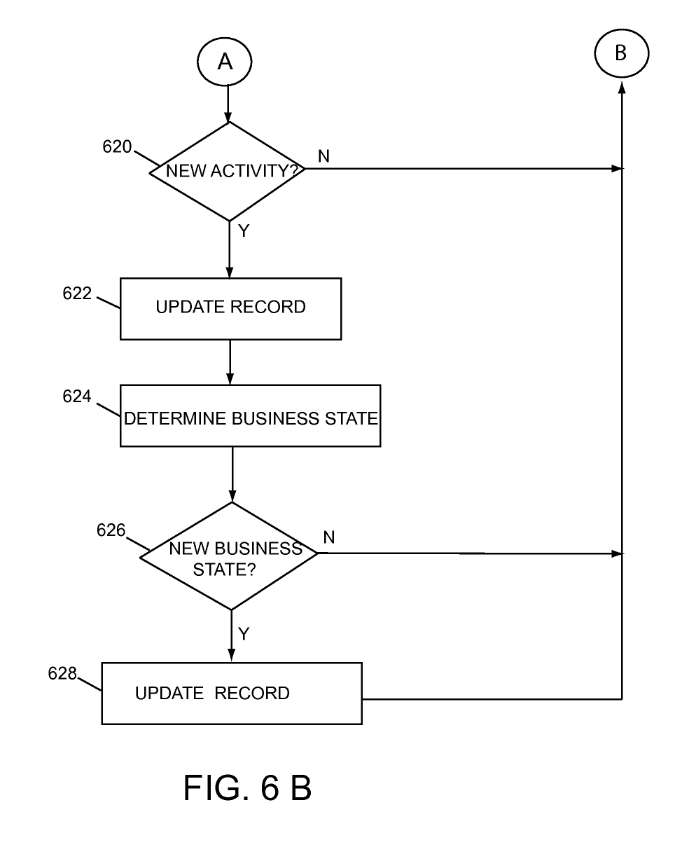

FIGS. 6A, 6B show an example method 600 that can be practiced at the CIS 300 to automatically inventory agricultural activity. The method 600 can begin at block 602 at which apparatus data is received. For example, the CIS 115 can receive apparatus data from the ADU 110 onboard apparatus 105a. At block 604 the apparatus data can be sorted by apparatus identification. As discussed above, each transmission from an ADU can include information that uniquely identifies the particular apparatus, and can also include operator identity information. The CIS 115 can be configured to receive apparatus data from a plurality of ADUs and can sort the data by apparatus identification in order to track the activity of each individual apparatus and perform the method 600 for each apparatus. At decision block 606 a determination can be made as to whether an apparatus is currently within the confines of a predetermined field. As discussed above, the CCD 302 can compare location data included in the ADU 110 transmission to a field listing stored at the database 310. If it is determined that an apparatus is within a predetermined field, then at decision block 608 a determination can be made as to whether an apparatus has newly entered a field. The CCD 302 can determine whether the most recent apparatus data indicate a crossing of a predetermined field boundary, or a continued presence in a previously entered field. If it is determined that an apparatus has entered a field, then at block 610 the field entry can be recorded. For example, a field record for the field 107a at the database 310 can be generated or updated to indicate entry of the apparatus 105a. In addition, an apparatus record for the apparatus 105a can be updated to indicate entry into the field 107a. Similarly, an operator record for the operator of apparatus 105a can be updated at the database 310. The date and time the apparatus entered the field can be recorded. For example, each ADU 110 transmission can include a date/time stamp. The date/time of the transmission which first indicates an apparatus position within a predefined field can be stored in one or more records maintained at a CIS. For example, database 310 can include records indexed by field, operator and apparatus that can be updated as apparatus data is received and processed at a CCD 302.

At block 612 the owner of the entered field can be determined. In an exemplary embodiment, the CCD 302 is configured to determine owner identity from a field listing record stored at the database 310. In an example embodiment, the owner can be recorded in a field record for the field 107a. In addition, operator and apparatus records can be updated to indicate the field in which they are currently located and its owner. In addition, an example method can include generating a business record in which the field 107a, its owner, and its business state is recorded. A business record can include information for one or more fields. Referring back to decision block 608, if it is determined that the apparatus has not newly entered a field, the method 600 can proceed to block 618.

At decision block 606, it may be determined that an apparatus is not currently located within a predetermined field. For example, an apparatus could be approaching a field not yet reached, or could have just departed a previously entered field. Accordingly, at decision block 614 a determination can be made as to whether the apparatus has just exited a field. For example, the CCD 302 can use previous location data or apparatus records stored at the database 310 to make this determination. If the location data indicate that the apparatus has just left a field, then at block 616, the field departure can be recorded. For example, field, apparatus and/or operator records can be updated to indicate that the apparatus is no longer in a field. A business record can be updated to indicate that the business state for a particular has changed to “has been worked”.

At block 618 the activity of an apparatus can be determined. As discussed previously in regard to method 500, and particularly blocks 504 and 506, apparatus data can indicate the state of various components, which can in turn be used to determine the type of activity in which an apparatus is engaged. For example, if at block 606 it is determined that an apparatus is not in a field, at block 618 the CCD 302 can use sensor data indicating that the apparatus is in motion and that an implement is in a raised or “travel mode” to determine that an apparatus is traveling. As a further example, location data indicating that an apparatus is not in a field, combined with sensor data that indicate that an apparatus is not moving, can be used at block 618 to determine that an apparatus is idle. As yet another example, location data indicating that an apparatus is presently in a predetermined field and sensor data indicating that the weight of a crop bin is increasing can be used to determine that an apparatus is harvesting crop. Apparatus activity can be recorded in records stored at database 310, for example in apparatus and/or operator records. Apparatus activity can be expressed in terms of agricultural elements.

At decision block 620, a decision can be made as to whether the apparatus activity determined at block 618 is a new activity or a continuation of activity previously commenced. In an example method, the activity determined at block 618 is compared to activity previously determined to see if a change in activity has occurred since the preceding transmission. If so, one or more records can be updated at block 622 to include the new activity. For example, an apparatus record, an operator record and a field record can be updated. Agricultural elements determined from apparatus data can be recorded.

At block 624 a business state can be determined based on agricultural elements, determined activity and/or apparatus data. For example, if at block 618 it is determined that, based on the received apparatus data, an apparatus is harvesting crop, and at block 620 it is determined that the crop harvesting is a new activity, which is subsequently recorded at block 622, then at block 624 a business state based on the new activity and/or other agricultural elements, can be determined. For example, the CCD 302 can determine that the business state for a field in which the apparatus is located is “being worked”. If this business state represents a change from the previously determined business state for the field in question, then at block 628, one or more records can be updated accordingly. For example, a business record that includes a list of fields and corresponding field business states can be updated at the database 310 and/or a field record for a particular field can be updated. If the business state is not different from the most recent business state, the example method 600 can continue at block 602 to receive additional apparatus data.

The method 600 is an exemplary process for conducting an automatic inventory of apparatus and operator activity. Upon its completion, the records stored at the CIS 115 can be used to compile one or more reports that can be sent to an administrative agency. In an example embodiment, the RGM 309 accesses a business record stored at the database 310 to generate a report that includes a list of fields, their owners, and their current business state. The report can be sent to an RRD at the administrative agency, which can then bill owners based on the report.

Thus, an automatic inventory system can use apparatus data to determine and track activity for an operator, an apparatus, and a field. Sensor data transmitted by a telemetry unit can be used to determine the type and location of agricultural activity performed. Based on the agricultural activity, a report characterizing a business state for a field can be generated. The business state for a field can be expressed in generalized terms so that a report's recipient need not have prerequisite knowledge of agriculture-specific terms.

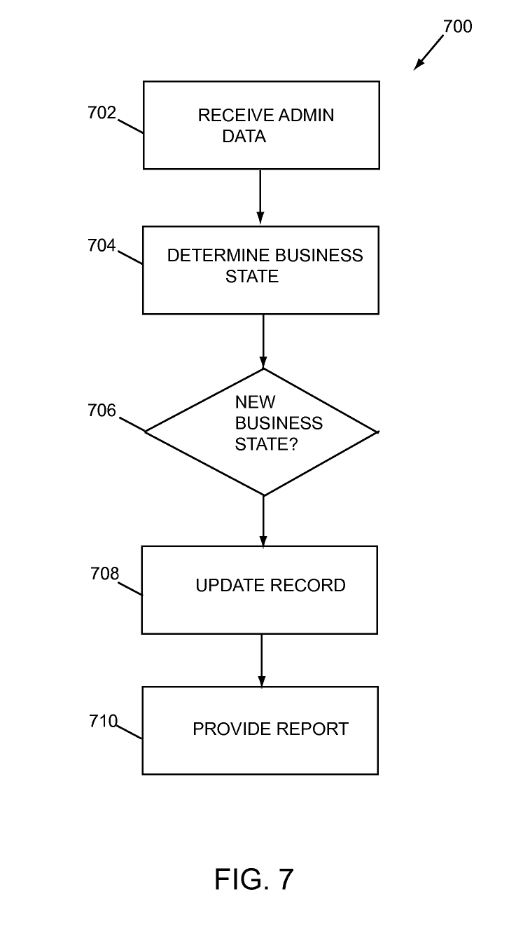

In many, if not most, cases, it is not necessary that an administrative service receive detailed agricultural information in order to perform its administrative responsibilities; too much extraneous information may only slow rather than facilitate the administrative process. The present invention can improve the efficiency of billing and administrative services. For example, a field may be scheduled for spraying. When an operator completes the spraying process, the system will detect that the job is completed and notify the billing service that the owner should be billed. The invention can be used to provide timely and accurate payment to an operator. The present system can be configured to identify the field worked and the number of hours the sprayer was operated. For example, an operator may be paid a flat fee as well as a commission for each field worked. The present invention facilitates the compilation of accurate records of information used in generating payment to operators as well as billing to field owners. After a field has been worked, a system can further provide fleet revenue assurance by characterizing a field by other business states, such as “Billed” or “Accounts Paid”. FIG. 7 shows an example method 700 in which administrative date can be used instead of the apparatus data shown in FIGS. 4 and 6. The method 700 can begin at block 702 in which administrative data can be received. For example, a billing service can provide data to a fleet revenue assurance system that an invoice has been sent to an owner of a field. At block 704, the determination can be made that the business state is now “Billed”. At block 706, a determination can be made as to whether the business state has changed. For example, the previous business state recorded was “Has Been Worked”, so the new business state reflects a change. Accordingly, at block 708 the record for the appropriate field can be updated to reflect the new business state “Billed”. Once payment has been received by a billing or administrative service, the record can be updated to a “Paid” state. In an example embodiment, when a field has a “Billed” state for longer than a predetermined time period, the system can alert a billing service to send out a second notice to an owner or billed party. The method 700 can further include providing a report at block 710.

In addition to determining a business state, an automatic inventory system can use apparatus data to generate and maintain records of specific activities performed by a particular operator and/or particular apparatus. These records can be used for billing and scheduling services, as well as for efficient resource management. Automating the inventory and reporting process reduces report inaccuracies due to human error, eliminates the need for familiarity with agricultural terms by a recipient and ensures delivery of reports in a timely manner. In addition, by abstracting out the field as a business object that is aware of the field owner, the CIS can interoperate with Customer Relationship Management to data-mine customer purchasing behaviors to therefore identify intelligent upselling opportunities. In addition, a revenue assurance system and method can be used to track and manage dispute settlements.

What is claimed is:

1. A system for automatic agricultural inventory reporting, comprising:
an apparatus data unit (ADU) configured to capture and transmit agricultural data associated with an agricultural apparatus; and
a central inventory system (CIS) configured to receive said agricultural data and use said agricultural data to determine a business state for a field.

2. The system of claim 1, wherein said CIS is configured to generate a report of said business state.

3. The system of claim 2, wherein said CIS is configured to transmit the report.

4. The system of claim 3, further comprising:
a report receiving device (RRD) configured to receive said report.

5. The system of claim 1, wherein said ADU comprises a telemetry unit at an agricultural vehicle.

6. The system of claim 1, wherein the ADU is configured to receive data from an implement.

7. The system of claim 1, wherein the ADU is configured to receive data from a sensor of the agricultural apparatus.

8. The system of claim 1, wherein said apparatus data comprises apparatus location data.

9. The system of claim 1, wherein said apparatus data comprises apparatus state data for a component of said agricultural apparatus.

10. The system of claim 1, wherein said apparatus data comprises apparatus state data for an implement used by said agricultural apparatus.

11. The system of claim 1, wherein said CIS comprises a central server configured to communicate with said ADU over a wireless network.

12. The system of claim 1, wherein said CIS is configured to convert said apparatus data to agricultural elements.

13. The system of claim 12, wherein said CIS is configured to map said agricultural elements to a business state.

14. The system of claim 1, wherein said RRD is associated with an administrative service.

15. A method for automatic inventory reporting, comprising:
receiving agricultural data associated with an agricultural apparatus;
determining a business state for a field using said agricultural apparatus data; and
generating a report of said business state.

16. The method of claim 15, wherein said receiving agricultural apparatus data comprises receiving apparatus location and state data.

17. The method of claim 15, wherein said determining a business state comprises determining whether an apparatus is located within a predefined field.

18. The method of claim 15, wherein said determining a business state comprises converting apparatus data to agricultural elements.

19. The method of claim 18, wherein said determining a business state further comprises mapping said agricultural elements to a business state.

20. The method of claim 15, further comprising providing the report of said business state to a report receiving device (RRD) associated with an administrative service.

21. The method of claim 15, further comprising compiling an apparatus record for an agricultural apparatus that includes activity performed by an agricultural apparatus.

22. The method of claim 21, further comprising providing said apparatus record to a report receiving device associated with an administrative service.

23. The method of claim 15, further comprising compiling an operator record for an operator of an apparatus.

24. The method of claim 23, further comprising providing said operator record to a report receiving device.

25. The method of claim 15, wherein said determining a business sate comprises determining whether a field has been worked.

26. The method of claim 15, further comprising:
billing a customer using said report.

27. The method of claim 15, further comprising:
providing said report to a billing party.

28. A central inventory system (CIS), comprising:
a field identification module (FIM) configured to determine whether an agricultural apparatus is located within a field; and
a Data Mapping Module (DMM) configured to use agricultural apparatus data to determine the business status of the field.

29. The CIS of claim 28, further comprising:
a Report Generating Module (RGM) to generate a report of the business status of the field.

30. The CIS of claim 28, wherein the FIM is configured to receive agricultural data from an Apparatus Data Unit (ADU) associated with the agricultural apparatus.
